(19) United States
(12) Patent Application Publication
(10) Pub. No.: US 2017/0243272 A1
(43) Pub. Date: Aug. 24, 2017

(54) SYSTEMS AND METHODS FOR PRECONFIGURATION OF AN IMAGE FORMING DEVICE

(71) Applicant: KYOCERA Document Solutions Inc., Osaka (JP)

(72) Inventor: Oleg Y. Zakharov, Walnut Creek, CA (US)

(73) Assignee: KYOCERA Document Solutions Inc., Osaka (JP)

(21) Appl. No.: 15/051,510

(22) Filed: Feb. 23, 2016

(51) Int. Cl. G06Q 30/06; G06Q 30/02

(52) U.S. Cl. CPC G06Q 30/0621; G06Q 30/0204

(57) ABSTRACT

A system includes a processor; a known customer preferences unit configured to request at least one particular known customer preference of a particular customer; a linking system configured to attempt, when at least one particular known customer preference is available, to identify a link between one or more of the at least one particular known customer preference of the particular customer and a modifiable device configuration setting of the particular image forming device, and further configured to set, when a link is identified between the one or more of the at least one particular known customer preference of the particular customer and the modifiable device configuration setting, the modifiable device configuration setting in accordance with the one or more of the at least one particular known customer preference of the particular customer; and a device controller configured to, before providing the particular image forming device to the particular customer, upload the modifiable device configuration setting as set by the linking system.

### TECHNICAL FIELD

The present disclosure relates to image forming devices, and more particularly relates to a system and method for preconfiguring an image forming device before providing it to a customer.

### BACKGROUND

Image forming devices, e.g., printers, scanners, copiers, facsimile device, and multifunction devices, have a large number of configuration settings, e.g., duplex printing, communication settings, email configurations, security and access control, default language, time zone, and an option to install custom or specific version of firmware. A manufacturer sets the configuration settings to default values and ships the device to a sales company, dealer or other business partner.

The customer, upon receipt, configures the settings of the image forming devices in accordance with his or her preferences. In some embodiments, the customer uses device software to navigate through graphical elements such as menu items, checkboxes and textboxes to set the parameters. Sometimes, an administrative user on a network computer accesses the image forming device via a web interface which connects to the image forming device via a network protocol, such as SNMP protocol or another network protocol (e.g., HTTP, TCP/IP).

It would be helpful to reduce the customer's burden to configure the configuration settings of image forming devices.

### SUMMARY

According to some embodiments, the present invention provides a method including identifying, via a processor, a modifiable device configuration setting of a particular image forming device to be provided to a particular customer; requesting, via the processor, at least one known customer preference of the particular customer; when at least one known customer preference is available, attempting via the processor to identify a link between one or more of the at least one known customer preferences of the particular customer and the modifiable device configuration setting; and after a link is identified between the one or more of the at least one known customer preference of the particular customer and the modifiable device configuration setting and before the particular image forming device is provided to the particular customer, setting via the processor the modifiable device configuration setting in accordance with the one or more of the at least one known customer preferences of the particular customer.

According to some embodiments, the present invention provides a system including a processor; a known customer preferences unit configured to request, via the processor, at least one particular known customer preference of a particular customer; a linking system configured to attempt, via the processor, when at least one particular known customer preference is available, to identify a link between one or more of the at least one particular known customer preferences of the particular customer and a modifiable device configuration setting of the particular image forming device, and further configured to set, via the processor, when a link is identified between the one or more of the at least one particular known customer preference of the particular customer and the modifiable device configuration setting, the modifiable device configuration setting in accordance with the one or more of the at least one particular known customer preference of the particular customer; and a device controller configured to, before providing the particular image forming device to the particular customer, upload the modifiable device configuration setting as set by the linking system.

### BRIEF DESCRIPTION OF THE DRAWINGS

The drawings are provided for purposes of illustration only and merely depict typical or example embodiments. These drawings are provided to facilitate the reader's understanding and shall not be considered limiting of the breadth, scope, or applicability various embodiments.

FIG. 1 illustrates a preconfiguration system, in accordance with some embodiments of the present invention.

FIG. 2 illustrates details of a firmware unit and device management controller, in accordance with some embodiments of the present invention.

FIG. 3 is a flow diagram illustrating a method of preconfiguring an image forming device, in accordance with some embodiments of the present invention.

FIG. 4 is a flow diagram illustrating a method of preconfiguring an image forming device, in accordance with some embodiments of the present invention.

FIG. 5 is a flow diagram illustrating a method of preconfiguring an image forming device, in accordance with some embodiments of the present invention.

FIG. 6 is a flow diagram illustrating a method of preconfiguring an image forming device, in accordance with some embodiments of the present invention.

### DETAILED DESCRIPTION

The following description is provided to enable a person skilled in the art to make and use various embodiments of the invention. Modifications are possible. The generic principles defined herein may be applied to the disclosed and other embodiments without departing from the spirit and scope of the invention. Thus, the claims are not intended to be limited to the embodiments disclosed, but are to be accorded the widest scope consistent with the principles, features and teachings herein.

Image forming devices, e.g., printers, scanners, copiers, facsimile devices, and/or multifunction devices, enable a user to set a variety of different configuration settings. For example, a printer (or printer function in a combination device) could be configured with settings involving paper size, color or monochrome, duplex printing, etc. Other example configuration settings may be grouped into hierarchical structures. They may include as follows:

A. Geographical settings such as time zone and language

B. Business profile settings such as paper format

C. Usage/workload settings such as alerts of minimum level of a toner, email notifications settings, security level (address book), and sleep mode (waiting time)

D. User experience

E. Special needs settings such as scan to email, scan to PDF, optical character recognition, etc.

Configuration settings may be in any format, e.g., a database format or XML format. An example XML format is as follows:

<Geographical>

<timezone></timezone>

<language></ language >
<Geographical>

In some embodiments, a manufacturer could preconfigure device configuration settings on a particular image forming device in accordance with customer preferences before the particular image forming device is provided (e.g., before it is shipped) to a customer. In some embodiments, preconfiguration could be performed in warehouse facilities in a unified way for all image forming devices being shipped to customers. A warehouse technical person can unpackage a particular image forming device from a manufacturer's container, test it, and identify it for shipment to a particular customer. The warehouse technical person can determine the customer preferences of the particular customer and preconfigure the particular image forming device based on the customer preferences. In some embodiments, the customer preferences may be determined from explicit and/or historical customer preferences. In some embodiments, one or more of the customer preferences may be generated from demographic customer preferences, e.g., based on the customer type.

In some embodiments, to preconfigure the particular image forming device, a warehouse technical person may connect the particular image forming device to a local warehouse network. A device management controller running on a local computer device accesses the particular image forming device via the local warehouse network.

In some embodiments, a particular warehouse technical person uses the device management controller to retrieve identification information of the particular image forming device, retrieve information regarding the modifiable device configuration settings on the particular image forming device based on the identification information, and retrieve known customer preferences for the particular customer. In some embodiments, known customer preferences for the particular image forming apparatus may be obtained explicitly from communications with the customer, from a Customer Relationship Management (CRM) system, from a Pre-sale Order (PO), etc. In some embodiments, known customer preferences may be obtained from historical records of customer preferences for other image forming devices belonging to the customer (e.g., devices in use, in lease and/or bought by same customer). In some cases, the historical records may pertain to image forming devices that are identical to the image forming device being purchased. In some cases, the historical records may pertain to different (e.g., older) versions (hardware, software and/or firmware) of the image forming device being provided. In some embodiments, customer preferences may be presumed from demographic customer preferences, e.g., from customer profile information, business type, industry type, organization type, etc. The customer preferences could be presumed from the most common configuration settings for the particular demographic.

In some embodiments, once the needed information has been retrieved, the device management system can automatically or in an interaction with a warehouse technical person identify links between the customer preferences (known or demographic) and the modifiable device configuration settings of the particular image forming device. If a link between a modifiable device configuration setting and an explicit customer preference for the particular image forming device is identified, the configuration setting on the particular image forming device can be set in accordance with the explicit customer preference in lieu of the default setting. If a link between a modifiable device configuration setting and a historically based customer preference for the particular image forming device is identified (and no link with an explicit customer preference is identified), the configuration setting on the particular image forming device can be set in accordance with the historically based customer preference in lieu of the default setting. If a link between the modifiable device configuration setting and a demographic preference is identified (and no link with a known customer preference is identified), the configuration setting on the particular image forming device can be set in accordance with the demographic customer preference in lieu of the default setting. If no link between the modifiable device configuration setting and a customer preference is identified, then the default configuration setting can be used.

The device management system can then upload the preconfigured modifiable device configuration settings to the image forming device accordingly.

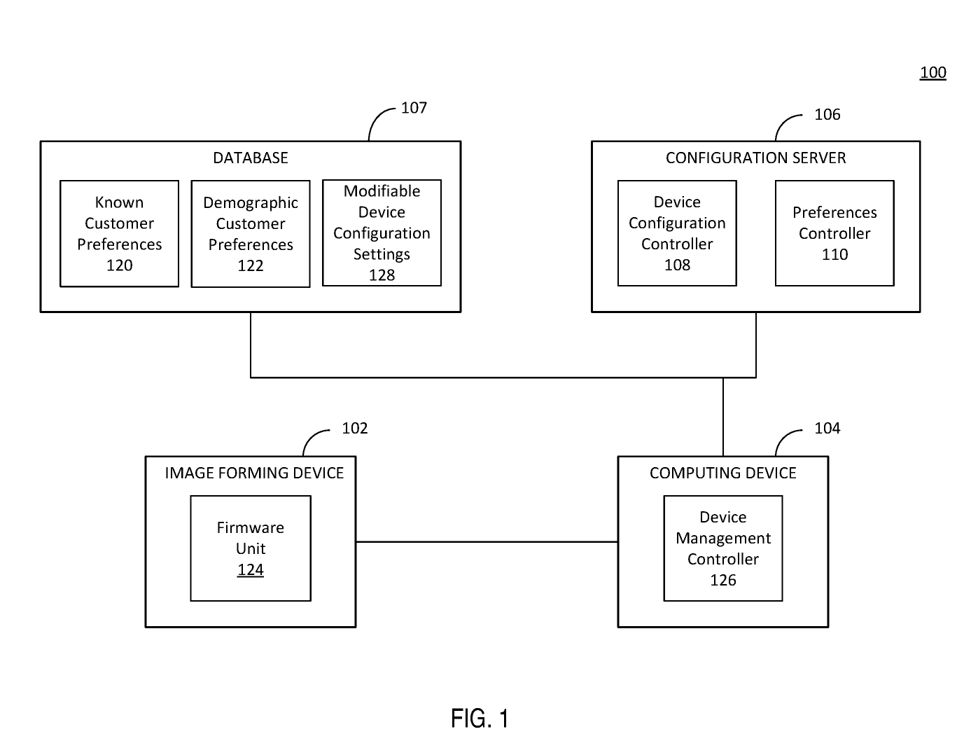

FIG. 1 illustrates a preconfiguration network system 100 including an image forming device 102, a computing device 104, a configuration server 106, and a database 107, according to some embodiments of the present invention.

The image forming device 102 may be, for example, a printer, a scanner, a copier, a facsimile device, and/or a multifunction peripheral that includes one or more of these functions. The image forming device 102 has a profile of modifiable device configuration settings and default values, which are typically consistent across all devices of the same version (hardware, e.g., brand, model and/or functions; firmware, and/or software). In some embodiments, the image forming device 102 includes a firmware unit 124 capable of communicating the modifiable device configuration settings and default values of the modifiable device configuration settings to the computing device 104.

The configuration server 106 may be, for example, a cloud server that is accessible from the computing device 104. The configuration server 106 may include a preferences controller 110 that includes hardware, software and/or firmware configured to obtain, manage and/or store known customer preferences 120 and/or demographic customer preferences 122 in the database 107. The configuration server 106 may include a device configuration controller 108 that includes hardware, software and/or firmware configured to obtain, manage and/or store information regarding the modifiable device configuration settings 128 of the image forming device 102 (based on its version). The device configuration controller 108 may store the modifiable device configuration settings 128 in the database 107.

The database 107 may be located on the configuration server 106 or external thereto. In some embodiments, the database 107 stores the known customer preferences 120 of device configuration settings associated with each image forming device 102 based on the version (hardware, firmware and/or software). The known customer preferences 120 may be associated with a device version identifiers and respective known customer preferences 120 of the modifiable device configuration settings. The known customer preferences 120 may include known customer preferences explicitly provided for the particular image forming device 102 being purchased and/or historically based device configuration settings of image forming devices 102 currently and/or previously owned by the customer.

In some embodiments, the database 107 stores demographic customer preferences 122 (e.g., the most common configuration settings based on customer type, industry type, organization type, business profile, and/or industry statistics).

The computing device 104 may be, for example, a desktop, laptop, mobile phone, tablet or other computing device. The computing device 104 may be located in a warehouse facility of a distributor. In some embodiments, the computing device 104 includes a device management controller 126. The device management controller 126 obtains known customer preferences 120 from the database 107. In the absence of known customer preferences 120 for one or more configuration settings, the device management controller 126 may obtain demographic customer preferences 122 from the database 107 to use as and/or supplement known customer preferences 120. In some embodiments, the device management controller 126 obtains the modifiable device configuration settings 128 from the configuration server 106. In some embodiments, the device management controller 126 obtains the modifiable device configuration settings 128 directly from the firmware unit 124 of the particular image forming device 102 identified for delivery to a particular customer.

Upon obtaining the modifiable device configuration settings 128, the known customer preferences 120 and/or the demographic customer preferences 122, the device management controller 126 attempts to identify links between the modifiable device configuration settings 128 and the known customer preferences 120 and/or demographic customer preferences 122.

If a link between a modifiable device configuration setting 128 and an explicitly provided known customer preference 120 for the particular image forming device 102 is identified, the device management controller 126 sets the configuration setting on the particular image forming device in accordance with the explicitly provided known customer preference 120. If a link between a modifiable device configuration setting 128 and a historically based known customer preference 120 for the particular image forming device 102 is identified (and no explicitly provided known customer preference 120 is available), the device management controller 126 sets the configuration setting on the particular image forming device in accordance with the historically based known customer preference 120. If a link between the modifiable device configuration setting and a demographic customer preference 122 is identified (and no link with a known customer preference 120 is available), the device management controller 126 sets the configuration setting on the particular image forming device 102 in accordance with the demographic customer preference 122. If no link between the modifiable device configuration setting 128 and a customer preference (known or demographic) is identified, the device management controller 126 uses the default configuration setting.

The device management controller 126 may communicate with the firmware unit 124 to upload the preconfigured modifiable device configuration setting values. In some embodiments, the firmware unit 124 may be capable of managing the modifiable device configuration settings 128 for several image forming functions (e.g., printing, scanning, faxing, and/or copying).

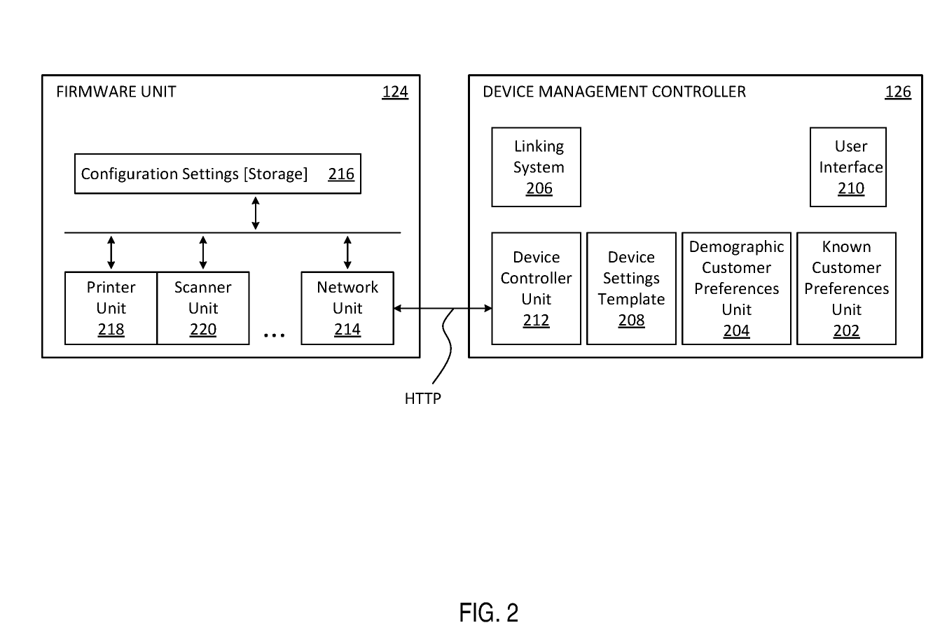

FIG. 2 illustrates details of the device management controller 126 of the computing device 104 in communication with the firmware unit 124 of an image forming device 102, according to some embodiments of the present invention.

In some embodiments, the device management controller 126 includes a known customer preferences unit 202, a demographic customer preferences unit 204, a linking system 206, a user interface 210, and a device controller unit 212.

The known customer preferences unit 202 includes hardware, software and/or firmware configured to obtain known customer preferences 120. In some embodiments, the known customer preferences unit 202 communicates with the database 107 to obtain the known customer preferences 120. The known customer preferences unit 202 may communicate directly with the customer to obtain explicitly known customer preferences 120 for the particular image forming device 102. The known customer preferences 120 may be determined from historical records, a Customer Relationship Management (CRM) system, a Pre-sale Order (PO), etc. In some embodiments, the known customer preferences unit 202 may communicate directly with image forming devices 102 belonging to the customer to obtain the current configuration settings.

The demographic customer preferences unit 204 includes hardware, software and/or firmware configured to obtain demographic customer preferences 122. The demographic customer preferences unit 204 may communicate with the database 107 to obtain the demographic customer preferences 122. The demographic customer preferences unit 204 may first determine the customer's demographic information (e.g., the customer type, organization type, industry type) and use the demographic information to examine stored configuration settings based on the particular image forming device version and the demographic information (e.g., customer type, organization type, and/or industry type). The demographic customer preferences 122 may be determined from known configuration settings of large cross sections of customers, based on demographic and image forming device type.

The linking system 206 includes hardware, software and/or firmware configured to obtain modifiable device configuration settings 128 for the particular image forming device 102 being shipped. In some embodiments, the linking system 206 communicates with the device controller unit 212 to obtain the modifiable device configuration settings 128 directly from the firmware unit 124 of the particular image forming device 102 identified for delivery to the customer. In some embodiments, the linking system 206 obtains the modifiable device configuration settings 128 from the configuration server 106.

The linking system 206 further includes hardware, software and/or firmware configured to identify links between the modifiable device configuration settings 128 and the customer preferences (known or demographic). In some embodiments, the linking system 206 sets the modifiable device configuration settings 128 hierarchically according to a trust factor. That is, explicitly provided known customer preferences 120 for the particular image forming device 102 may be deemed more trustworthy than those determined from historically based device settings. Historically based device settings for the particular image forming device 102 version may be deemed more trustworthy than those determined from historically based device settings of similar but not identical versions. Similarly, historically based device settings of similar but not identical versions may be deemed more trustworthy than demographic customer preferences 122. Demographic customer preferences may be deemed more trustworthy than default settings. Other hierarchies are possible.

If a link between a modifiable device configuration setting 128 and an explicitly provided known customer preference 120 for the particular image forming device 102 is identified, the linking system 206 sets the configuration setting on the particular image forming device in accordance with the explicitly provided known customer preference 120. If a link between a modifiable device configuration setting 128 and a historically based known customer preference 120 for the particular image forming device 102 is identified (and no explicitly provided known customer preference 120 is available), the linking system 206 sets the configuration setting on the particular image forming device in accordance with the historically based known customer preference 120. If a link between the modifiable device configuration setting and a demographic customer preference 122 is identified (and no link with a known customer preference 120 is available), the linking system 206 sets the configuration setting on the particular image forming device 102 in accordance with the demographic customer preference 122. If no link between the modifiable device configuration setting and a customer preference (known or demographic) is identified, the linking system 206 uses the default configuration setting.

In some embodiments, the linking system 206 populates a device settings template 208, which in some embodiments lists the set of modifiable device configuration settings 128, to include the customer preferences (known or demographic) according to a configured hierarchy, e.g., the hierarchy noted above.

In some embodiments, the user interface 210 includes hardware, software and/or firmware configured to communicate with the warehouse technical person to support configuration and/or review of modifiable device configuration settings 128. In some embodiments, the user interface 210 presents the set of modifiable device configuration settings 128 in a list format, and highlights the modifiable device configuration setting values in a color to represent its level in the hierarchy. For example, the user interface 210 may highlight all explicitly provided known customer preferences 120 in green, all historically based known customer preferences 120 in blue, all demographic customer preferences 122 in yellow, and all default values in red. The user interface 210 allows the warehouse technical person to modify the device settings, if they want a different setting than those the linking system 206 selected.

The device controller unit 212 also includes hardware, software and/or firmware configured to upload the preconfigured modifiable device configuration settings of the particular image forming device 102. In some embodiments, the device management controller 126 may upload the device settings template 208 into the configuration settings 216 of the firmware unit 124.

In some embodiments, the known customer preferences unit 202 may update the known customer preferences 120 with the preconfigured device configuration setting values generated for the particular image forming device 102.

The firmware unit 124 includes a network unit 214, a printer unit 218, a scanner unit 220 and configuration settings 216.

The network unit 214 includes hardware, software and/or firmware configured to communicate with the device controller unit 212, possibly via HTTP or any other protocol, and capable of interacting with the configuration settings 216 to set the configuration values.

The configuration settings 216 include the values associated with each of the modifiable device configuration settings 128. The configuration settings 216 may also maintain the default setting values associated with each of the modifiable device configuration settings 128.

The printer unit 218 includes hardware, software and/or firmware configured to print based on the configuration settings 216.

The scanner unit 220 includes hardware, software and/or firmware configured to scan based on the configuration settings 216.

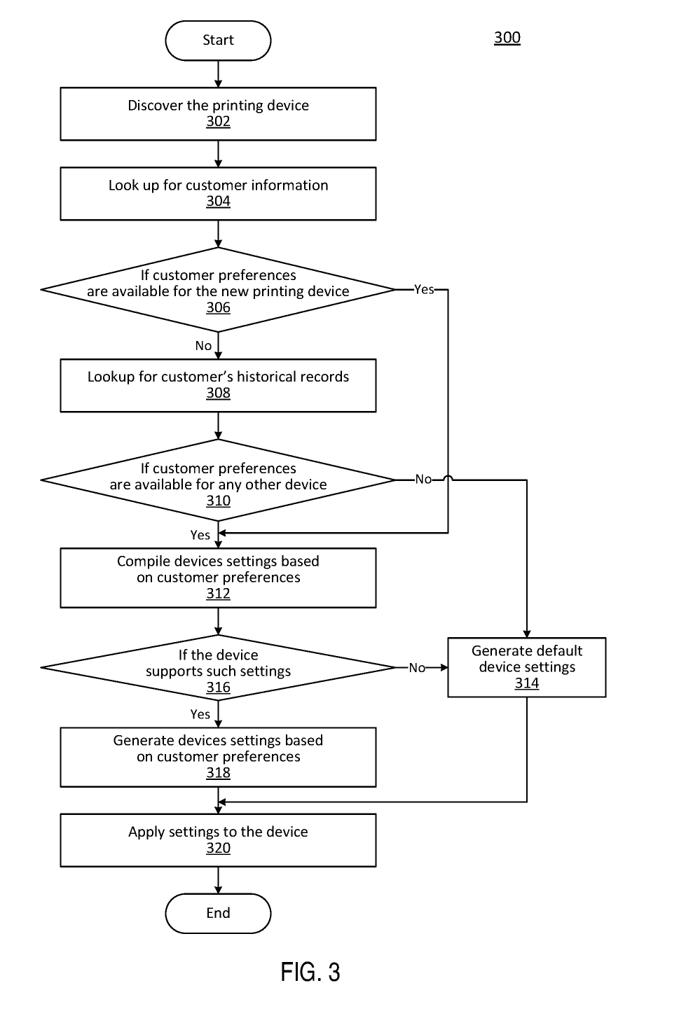

FIG. 3 is a flow diagram illustrating a method 300 of preconfiguring an image forming device 102, according to some embodiments of the present invention. The method 300 begins in step 302 with the computing device 104 discovering the image forming device 102. In step 304, the known customer preferences unit 202 attempts to retrieve known customer preferences 120. In step 306, the linking system 206 determines if explicitly provided customer preferences 120 are available for the particular image forming device 102 being shipped. If explicitly provided customer preferences 120 are available, then the linking system 206 in step 312 compiles device settings based on the explicitly provided customer preferences 120 and method 300 proceeds to step 316. In step 316, the linking system 206 generates the device settings based on the customer preferences 120. If explicitly provided customer preferences 120 are unavailable, then the linking system 206 in step 308 attempts to retrieve historical records of other image forming devices 102 of the customer. In step 310, the linking system 206 determines if the historical records are available. If the historical records are available, then the linking system 206 in step 312 presumes customer preferences from the historical records for the particular image forming device 102, and compiles the device settings based on the historically based customer preferences 120 generated from the historical records, and method 300 proceeds to step 316 to generate the device settings based on the historically based customer preferences 120. If no historical records are available, then the linking system 206 in step 314 uses default device settings. In step 320, the device controller unit 212 uploads the preconfigured modifiable device configuration settings to the image forming device 102. Method 300 then ends.

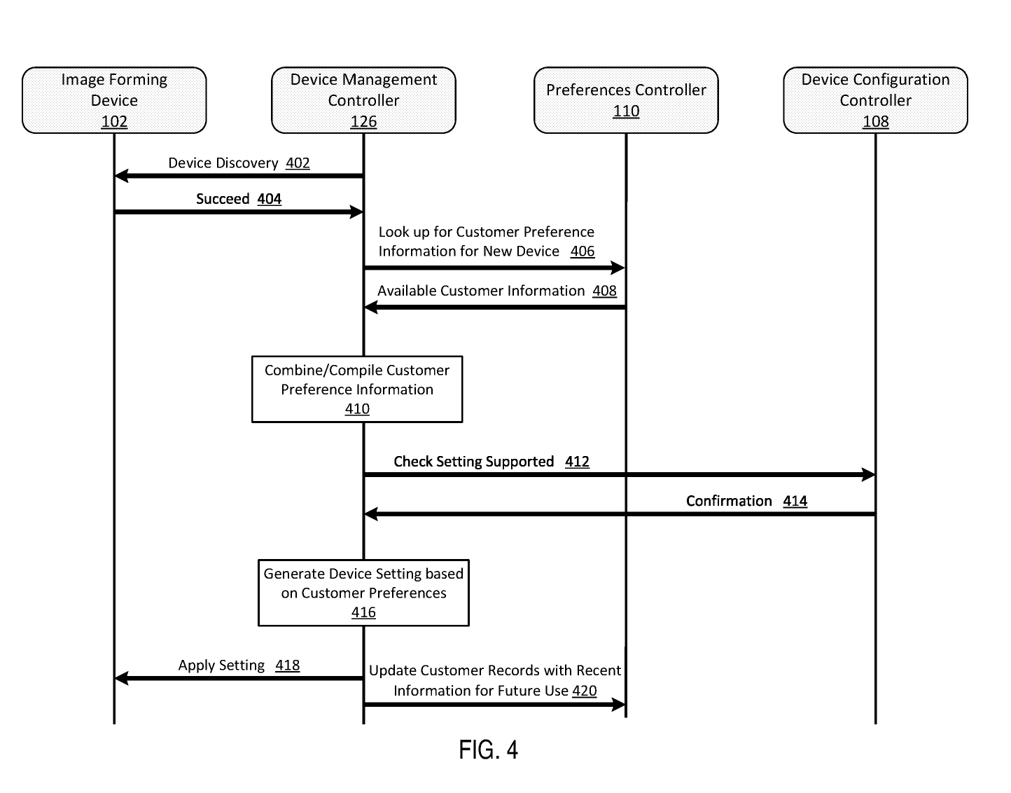

FIG. 4 is a flow diagram illustrating a method 400 of preconfiguring an image forming device 102 according to some embodiments of the present invention in which an explicitly provided customer preference 120 is available for a particular image forming device 102 and the particular image forming device 102 supports the setting. Method 400 begins in step 402 with the device management controller 126 seeking to discover the image forming device 102. In step 404, the image forming device 102 provides a confirmation response to the device management controller 126. In step 406, the device management controller 126 contacts the preferences controller 110 to attempt to retrieve explicitly provided known customer preferences 120 for the particular image forming apparatus 102 being shipped. In step 408, the preferences controller 110 retrieves explicitly provided customer preferences 120 from the database 107 and provides the explicitly provided customer preferences 120 to the device management controller 126. In step 410, the device management controller 126 combines/compiles the known customer preferences 120. In step 412, the device management controller 126 contacts the device configuration controller 108 to determine if each explicitly provided customer preference 120 is a modifiable device configuration settings 128. In step 414, the device configuration controller 108 confirms to the device management controller 126 that the explicitly provided customer preference 120 is supported. In some embodiments, instead of seeking confirmation from the device configuration controller 108, the device management controller 126 may retrieve the modifiable device configuration settings 128 from the device configuration controller 108 of the configuration server 106 and perform a linking process itself to determine supported configuration settings for which explicitly provided customer preferences 120 are available. In step 416, the device management controller 126 sets the preconfigured modifiable device configuration settings based on the explicitly provided known customer settings 120. In step 418, the device management controller 126 uploads the settings to the image forming device 102. In step 420, the device management controller 126 updates customer records/preferences 120 with recent information for future use.

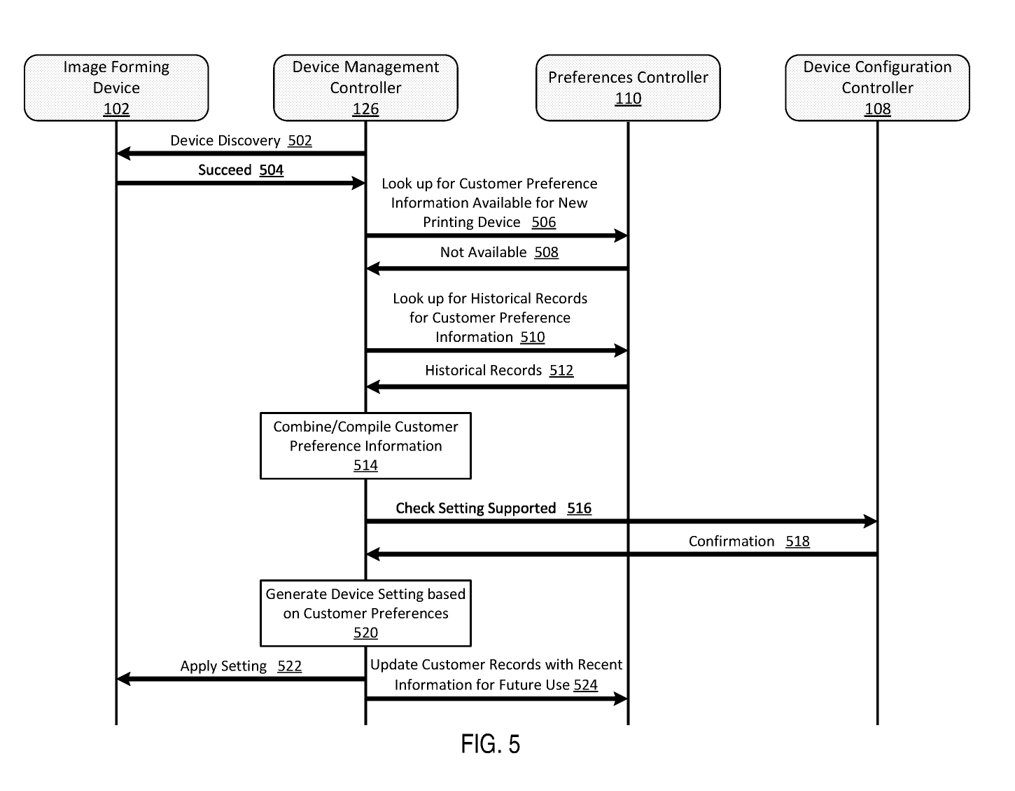

FIG. 5 is a flow diagram illustrating a method 500 of preconfiguring an image forming device 102 according to some embodiments of the present invention in which the known configuration preference 120 for a particular image forming device 102 is unavailable. Method 500 begins with the device management controller 126 seeking to discover the image forming device 102. In step 504, the image forming device 102 provides a confirmation response to the device management controller 126. In step 506, the device management controller 126 contacts the preferences controller 110 to attempt to retrieve explicitly provided known customer preferences 120 for a particular new image forming apparatus 102. In step 508, the preferences controller 110 informs the device management controller 126 that the explicitly provided known customer preferences 120 for the particular new image forming device 102 are unavailable. In step 510, the device management controller 126 contacts the preferences controller 110 to attempt to retrieve historical records of known customer preferences 120 for the particular customer. In step 512, the preferences controller 110 provides the historical records. In step 514, the device management controller 126 combines/compiles the historically based known customer preferences 120. In step 516, the device management controller 516 contacts the device configuration controller 108 to determine if the image forming device 102 supports each historically based known customer preference 120. In step 518, the device configuration controller 108 confirms to the device management controller 126 that the historically based known customer preference 120 is supported. In some embodiments, instead of seeking confirmation from the device configuration controller 108, the device management controller 126 may retrieve the modifiable device configuration settings 128 from the device configuration controller of the configuration server 106 and perform a linking process itself to determine supported configuration settings for which historically based known customer preferences 120 are available. In step 520, the device management controller 126 generates the preconfigured modifiable device configuration settings based on the historically based known customer settings 120. In step 522, the device management controller 126 uploads the settings to the image forming device 102. In step 524, the device management controller 126 updates customer records/preferences 120 with recent information for future use.

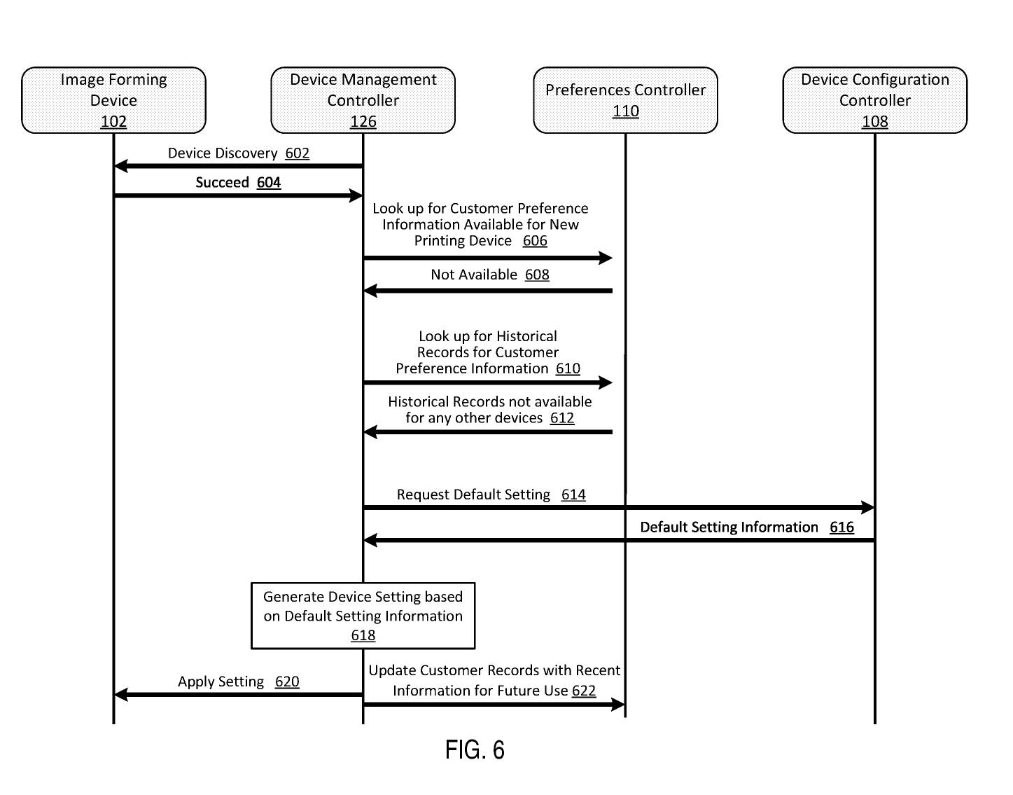

FIG. 6 is a flow diagram illustrating a method 600 of preconfiguring an image forming device 102 according to some embodiments of the present invention in which the image forming device 102 does not support a setting corresponding to a customer preference 120. Method 600 begins with the device management controller 126 seeking to discover the image forming device 102. In step 604, the image forming device 102 provides a confirmation response to the device management controller 126. In step 606, the device management controller 126 contacts the preferences controller 110 to attempt to retrieve explicitly provided known customer preferences 120 for a particular image forming apparatus 102 being provided to the particular customer. In step 608, the preferences controller 110 informs the device management controller 126 that explicitly provided known customer preferences 120 for the particular new image forming device 102 are unavailable. In step 610, the device management controller 126 contacts the preferences controller 110 to attempt to retrieve historical records of known customer preferences 120 for the particular customer. In step 612, the preferences controller 110 informs the device management controller 126 that the historical records are unavailable. In step 614, the device management controller 126 contacts the device configuration controller 108 to request a default setting. In step 616, the device configuration controller 108 provides the default setting to the device management controller 126. In step 618, the device management controller 126 generates the preconfigured modifiable device configuration settings based on the default setting. In step 620, the device management controller 126 uploads the preconfigured modifiable device configuration settings to the image forming device 102. In some embodiments, the default settings may be already set on the image forming device 102, and thus the device management controller 126 may skip the steps of generating and uploading default settings. In step 622, the device management controller 126 updates customer records/preferences 120 with recent information for future use.

The foregoing description of the preferred embodiments of the present invention is by way of example only, and other variations and modifications of the above-described embodiments and methods are possible in light of the foregoing teaching. The various embodiments set forth herein may be implemented utilizing hardware, software, or any desired combination thereof. For that matter, any type of logic may be utilized which is capable of implementing the various functionality set forth herein. Components may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

1. A method comprising:
identifying, via a processor, a modifiable device configuration setting of a particular image forming device to be provided to a particular customer;
requesting, via the processor, at least one known customer preference of the particular customer;
when at least one known customer preference is available, attempting via the processor to identify a link between one or more of the at least one known customer preference of the particular customer and the modifiable device configuration setting; and
after a link is identified between the one or more of the at least one known customer preference of the particular customer and the modifiable device configuration setting and before the particular image forming device is provided to the particular customer, setting via the processor the modifiable device configuration setting in accordance with the one or more of the at least one known customer preference of the particular customer.

2. The method of claim 1, wherein the processor is a component of a computer device located at a warehouse facility.

3. The method of claim 1, wherein the identifying of the modifiable device configuration setting includes querying the particular image forming device.

4. The method of claim 1, wherein the identifying of the modifiable device configuration setting includes querying a server device that maintains information on modifiable device configuration settings for a plurality of image forming devices based on version information.

5. The method of claim 1, wherein the at least one known customer preference includes at least one known customer preference for the particular image forming device explicitly provided by the particular customer.

6. The method of claim 1, wherein the at least one known customer preference includes at least one known customer preference generated based on historical records of customer preferences for other image forming devices.

7. The method of claim 6, wherein the other image forming devices include versions of configuration settings of image forming devices different than the particular image forming device.

8. The method of claim 1, wherein
the step of attempting to identify a link between the one or more of the at least one known customer preference of the particular customer and the modifiable device configuration setting comprises
attempting to identify a link between one or more of at least one explicitly provided known customer preference of the particular customer and the modifiable device configuration setting; and
attempting to identify a link between one or more of at least one historically based known customer preference of the particular customer and the modifiable device configuration setting; and
the step of setting the modifiable device configuration setting in accordance with the one or more of the at least one known customer preference of the particular customer comprises
after a link is identified between one or more of at least one explicitly provided known customer preference of the particular customer and the modifiable device configuration setting, setting the modifiable device configuration setting in accordance with the one or more of the at least one explicitly provided known customer preference of the particular customer; and
after a link is not identified between one or more of at least one explicitly provided known customer preference of the particular customer and the modifiable device configuration setting and a link is identified between one or more of at least one historically based known customer preference of the particular customer and the modifiable device configuration setting, setting the modifiable device configuration setting in accordance with the one or more of the at least one historically based known customer preference of the particular customer.

9. The method of claim 1, further comprising
after a link is not identified between the at least one known customer preference and the modifiable device configuration setting,
requesting, via the processor, at least one demographic customer preference;
when at least one demographic customer preference is available, attempting via the processor to identify a link between one or more of the at least one demographic customer preference and the modifiable device configuration setting; and
after a link is identified between the one or more of the at least one demographic customer preference and the modifiable device configuration setting and before providing the particular image forming device to the particular customer, setting via the processor the modifiable device configuration setting in accordance with the one or more of the at least one demographic customer preference.

10. The method of claim 1, further comprising
after no link is identified between the one or more of the at least one known customer preference of the particular customer and the modifiable device configuration setting, setting the modifiable device configuration setting to a default value.

11. The method of claim 1, further comprising
storing the value of the modifiable device configuration setting for the particular image forming apparatus in association with the particular user.

12. A system comprising:
a processor;
a known customer preferences unit configured to request, via the processor, at least one particular known customer preference of a particular customer;
a linking system configured to attempt, via the processor, when at least one particular known customer preference is available, to identify a link between one or more of the at least one particular known customer preference of the particular customer and a modifiable device configuration setting of the particular image forming device, and further configured to set, via the processor, when a link is identified between the one or more of the at least one particular known customer preference of the particular customer and the modifiable device configuration setting, the modifiable device configuration setting in accordance with the one or more of the at least one particular known customer preference of the particular customer; and
a device controller configured to, before providing the particular image forming device to the particular customer, upload the modifiable device configuration setting as set by the linking system.

13. The system of claim 12, wherein the processor is a component of a computer device located at a warehouse facility.

14. The system of claim 12, wherein the device controller is further configured to query the particular image forming device to identify the modifiable device configuration setting.

15. The system of claim 12, wherein the linking system is configured to query, based on version information of the particular image forming device, a server device that maintains information on modifiable device configuration settings for a plurality of image forming devices to identify the modifiable device configuration setting of the particular image forming device.

16. The system of claim 12, wherein the at least one known customer preference includes at least one known customer preference for the particular image forming device explicitly provided by the particular customer.

17. The system of claim 12, wherein the at least one known customer preference includes at least one known customer preference generated based on historical records of customer preferences for other image forming devices.

18. The system of claim 17, wherein the other image forming devices include versions of configuration settings of image forming devices different than the particular image forming device.

19. The system of claim 12, wherein
the linking system is further configured to attempt to identify a link between the one or more of the at least one particular known customer preference of the particular customer and the modifiable device configuration setting of the particular image forming device by
attempting to identify a link between one or more of at least one explicitly provided known customer preference of the particular customer and the modifiable device configuration setting; and
attempting to identify a link between one or more of at least one historically based known customer preference of the particular customer and the modifiable device configuration setting; and
the linking system is further configured to set the modifiable device configuration setting in accordance with the one or more of the at least one particular known customer preference of the particular customer by
after a link is identified between one or more of at least one explicitly provided known customer preference of the particular customer and the modifiable device configuration setting, setting the modifiable device configuration setting in accordance with the one or more of the at least one explicitly provided known customer preference of the particular customer; and
after a link is not identified between one or more of at least one explicitly provided known customer preference of the particular customer and the modifiable device configuration setting and a link is identified between one or more of at least one historically based known customer preference of the particular customer and the modifiable device configuration setting, setting the modifiable device configuration setting in accordance with the one or more of the at least one historically based known customer preference of the particular customer.

20. The system of claim 12, further comprising
a demographic customer preferences unit configured to request, via the processor, at least one demographic customer preference after a link is not identified between the at least one particular known customer preference and the modifiable device configuration setting;
and wherein the linking system is further configured to
when at least one demographic customer preference is available, attempt via the processor to identify a link between one or more of the at least one demographic customer preference and the modifiable device configuration setting; and
after a link is identified between the one or more of the at least one demographic customer preference and the modifiable device configuration setting and before providing the particular image forming device to the particular customer, set via the processor the specific one of the modifiable device configuration settings in accordance with the one or more of the at least one demographic customer preference.

21. The system of claim 12, wherein the linking system is further configured to, after no link is identified between the one or more of the at least one particular known customer preference of the particular customer and the modifiable device configuration setting, set the modifiable device configuration setting to a default value.

22. The system of claim 12, wherein the linking system is further configured to store the value of the modifiable device configuration setting for the particular image forming apparatus in association with the particular user.
